(19) United States
(12) Patent Application Publication
(10) Pub. No.: US 2023/0196435 A1
(43) Pub. Date: Jun. 22, 2023

(54) Subscription-Based Service System

(71) Applicant: S&P Global Inc., New York, NY (US)

(72) Inventors: Ratheen Chaturvedi, Mumbai (IN); Arpit Agrawal, Gurugram (IN)

(21) Appl. No.: 17/644,916

(22) Filed: Dec. 17, 2021

(51) Int. Cl. G06Q 30/06; G06N 20/00; G06N 7/00

(52) U.S. Cl. CPC G06Q 30/0631; G06N 20/00; G06N 7/005; G06Q 30/0641

(57) ABSTRACT

A method, apparatus, system, and computer program code for identifying at-risk items. Raw account data is collected for a set of accounts, each account comprising a set of subscriptions to a set of items. The raw account data is transformed to generate a first subset of account data that comprises only accounts having subscriptions that have been modified, and a second subset of account data that comprises only accounts having subscriptions that are unmodified. An interaction function it is determined, by a machine learning model, according to the first subset of account data. A number of at-risk items is determined, by the machine learning model. Each at-risk item has a respective probability of modification based on the interaction function. The at-risk items are displayed on a graphical user interface.

### BACKGROUND

### 1. Field

The disclosure relates generally to an improved computer system and, more specifically, to a method, apparatus, computer system, and computer program product for improved machine learning recommendation systems.

### 2. Description of the Related Art

Collaborative filtering is the process of filtering for information or patterns using techniques involving collaboration among multiple agents, viewpoints, or data sources, typically involving very large data sets. Automatic predictions for a single user are made based on the by collected preferences of many users.

Generating inferences from implicit feedback involves estimating scores of unobserved entries, which are used for ranking the items. Model-based approaches assume that data can be generated (or described) by the model:

ŷᵤᵢ=f(u,i|Θ)

### Wherein:

ŷᵤᵢ is the predicted score of interaction yᵤᵢ,
Θ is the model parameters, and
f denotes the interaction function that maps model parameters to the predicted score.

Known approaches for estimating model parameters Θ generally follow a machine learning paradigm that optimizes an objective loss function—typically pointwise loss or pairwise loss. These known approaches estimate model parameters Θ using matrix factorization, applying an inner product on the latent features of users and items.

Matrix factorization (MF) is a collaborative filtering technique that projects users and items into a shared latent space. Each user and item are associated with a real-valued vector of latent features. A user's interaction on an item is modelled as the inner product of their latent vectors. For example, matrix factorization estimates an interaction yᵤᵢ as the inner product of pᵤ and qᵢ:

ŷᵤᵢ=f(u,i|pᵤ,qᵢ)=pᵤ^{T}qᵢ=Σₖ₌₁^{K}pᵤₖqᵢₖ

### Wherein:

pᵤ is the latent vector for user u;
qᵢ is the latent vector for item i; and
K denotes the dimension of the latent space.

Matrix factorization maps users and items to the same latent space, measuring the similarity between two users as the inner product, or equivalently, the cosine of the angle between latent vectors. Depending on the relative similarities between user pairs (such as a the Jaccard coefficient), a large ranking loss is incurred when using a simple and fixed inner product used to estimate complex user-item interactions in low-dimensional latent space. Increasing the number of latent factors K may alleviate ranking loss but can adversely impact model generalization due to overfitting the data, especially in sparse settings.

### SUMMARY

According to one embodiment of the present invention, a computer-implemented method provides for identifying at-risk items. The method comprises using a number of processors to perform the steps of: collecting raw account data for a set of accounts, each account comprising a set of subscriptions to a set of items; transforming the raw account data to generate a first subset of account data that comprises only accounts having subscriptions that have been modified, and a second subset of account data that comprises only accounts having subscriptions that are unmodified; determining, by a machine learning model, a interaction function according to the first subset of account data; determining, by the machine learning model, a number of at-risk items, wherein each at-risk item has a respective probability of modification based on the interaction function; and displaying the at-risk items on a graphical user interface.

According to another embodiment of the present invention, a computer system for identifying at-risk items comprises a storage device configured to store program instructions and one or more processors operably connected to the storage device. The one or more processors are configured to execute the program instructions to cause the system to: collect raw account data for a set of accounts, each account comprising a set of subscriptions to a set of items; transform the raw account data to generate a first subset of account data that comprises only accounts having subscriptions that have been modified, and a second subset of account data that comprises only accounts having subscriptions that are unmodified; determine, by a machine learning model, an interaction function according to the first subset of account data; determine, by the machine learning model, a number of at-risk items, wherein each at-risk item has a respective probability of modification based on the interaction function; and display the at-risk items on a graphical user interface.

According to yet another embodiment of the present invention, a computer program product comprises a computer-readable storage media with program instructions embodied on the computer-readable storage media for identifying at-risk items. The program code is executable by a computer system to perform the steps of: collecting raw account data for a set of accounts, each account comprising a set of subscriptions to a set of items; transforming the raw account data to generate a first subset of account data that comprises only accounts having subscriptions that have been modified, and a second subset of account data that comprises only accounts having subscriptions that are unmodified; determining, by a machine learning model, an interaction function according to the first subset of account data; determining, by the machine learning model, a number of at-risk items, wherein each at-risk item has a respective probability of modification based on the interaction function; and displaying the at-risk items on a graphical user interface.

### BRIEF DESCRIPTION OF THE DRAWINGS

FIG. 1 is a pictorial representation of a network of data processing systems in which illustrative embodiments may be implemented;

FIG. 2 is a block diagram of a service environment depicted in accordance with an illustrative embodiment;

FIG. 3 is a block diagram of a neural collaborative filtering framework depicted in accordance with an illustrative embodiment;

FIG. 4 is a dashboard depicted in accordance with an illustrative embodiment;

FIG. 5 is a flowchart of a process for identifying at-risk items depicted in accordance with an illustrative embodiment;

FIG. 6, a flowchart of a process for determining an interaction function is depicted in accordance with an illustrative embodiment;

FIG. 7 is a flowchart of a process for filtering at-risk items depicted in accordance with an illustrative embodiment; and

FIG. 8 is a block diagram of a data processing system depicted in accordance with an illustrative embodiment.

### DETAILED DESCRIPTION

The illustrative embodiments leverage account data for a large number of accounts to train a Neural Collaborative Filtering Model (a deep learning methodology) to predict account health and subscription changes for an individual account. The neural network architecture of the illustrative embodiments model latent information of users and items (pages of content) and devise a system that uses collaborative filtering without content data for the individual account.

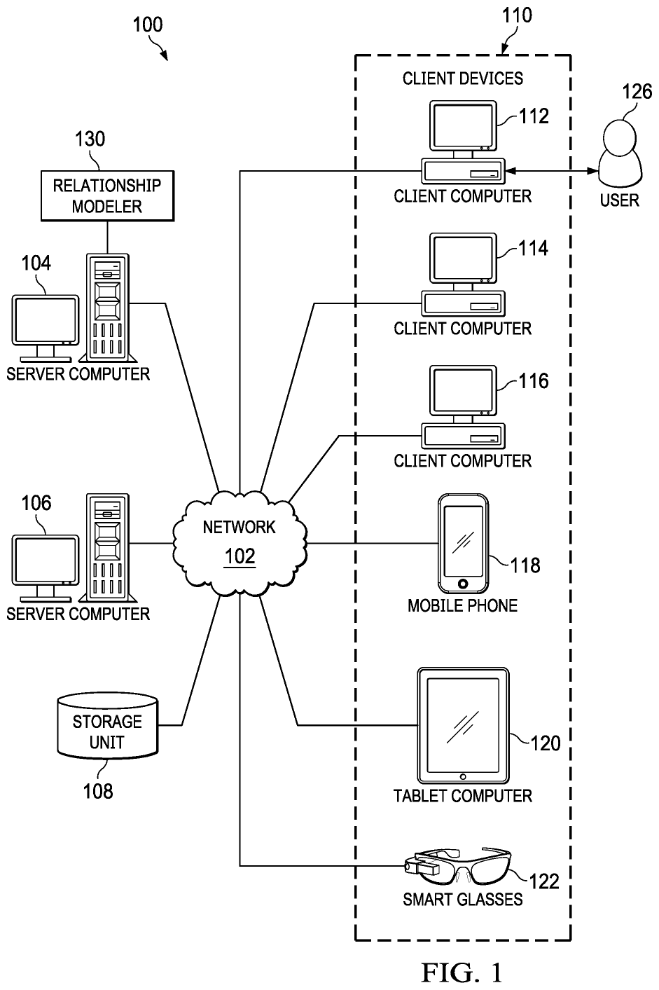

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user 126 operates client computer 112. In this illustrative example, relationship modeler 130 can run on server computer 104. In another illustrative example, relationship modeler 130 can be run in a remote location such as on client computer 114 and can take the form of a system instance of the application. In yet other illustrative examples, relationship modeler 130 can be distributed in multiple locations within network data processing system 100. For example, relationship modeler 130 can run on client computer 112 and on client computer 114 or on client computer 112 and server computer 104 depending on the particular implementation.

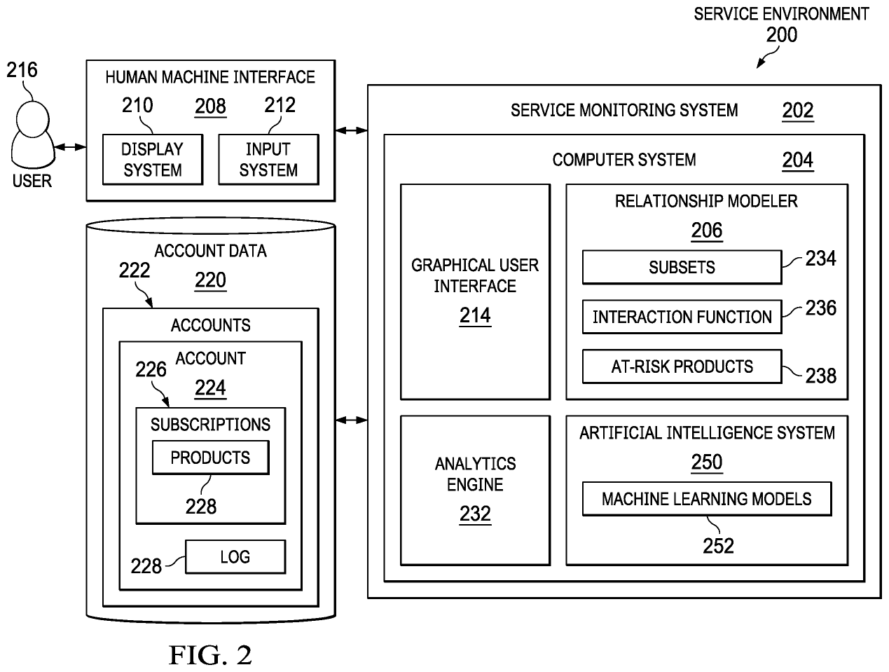

With reference now to FIG. 2, a block diagram of a service environment is depicted in accordance with an illustrative embodiment. In this illustrative example, service environment 200 includes components that can be implemented in hardware such as the hardware shown in network data processing system 100 in FIG. 1.

As depicted, service monitoring system 202 comprises computer system 204 and relationship modeler 206. Relationship modeler 206 runs in computer system 204. relationship modeler 206 can be implemented in software, hardware, firmware, or a combination thereof. When software is used, the operations performed by relationship modeler 206 can be implemented in program code configured to run on hardware, such as a processor unit. When firmware is used, the operations performed by relationship modeler 206 can be implemented in program code and data and stored in persistent memory to run on a processor unit. When hardware is employed, the hardware may include circuits that operate to perform the operations in relationship modeler 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, human machine interface 208 comprises display system 210 and input system 212. Display system 210 is a physical hardware system and includes one or more display devices on which graphical user interface 214 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 216 is a person that can interact with graphical user interface 214 through user input generated by input system 212 for computer system 204. Input system 212 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 208 can enable user 216 to interact with one or more computers or other types of computing devices in computer system 204. For example, these computing devices can be client devices such as client devices 110 in FIG. 1.

Relationship modeler 206 operates on account data 220. Account data 220 contains information regarding accounts 222 of service clients, including subscriptions 226 to one or more items 228, as well as log 230 of any modifications to subscriptions 226, such as adding or dropping items 228 from subscriptions 226. Log 230 can be generated in real time as modifications are made to subscriptions 226.

As used herein, an “item” is a software service that may be provided as part of a suite of Internet-provided services. These software services can be offered to clients as a package, or individually on a subscription basis. For example, a business client may subscribe to one or more services and access those services via the Internet. In one illustrative example, software services is market analysis software, including ratings, benchmarks and analytics services for global capital and commodity markets.

Account data 220 can include one or more dimensions of data regarding accounts 222. These data dimensions can include, for example, but not limited to, industry sectors for an account holder, subscribed services, subscription fee amounts, and a number of licenses associated with account 224.

Analytics engine 232 receives account data 220. Analytics engine 232 transforms account data 220, generating subsets 234 from the account data 220 in a raw form based on log 230. For example, analytics engine 232 might generate a first subset of account data that comprises only accounts having subscriptions that have been modified, as indicated in log 230. Analytics engine 232 might generate a second subset of account data that comprises only accounts having subscriptions that are unmodified, as indicated in log 230.

In some illustrative examples, relationship modeler 206 can use artificial intelligence system 250. Artificial intelligence system 250 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 250 can include a set of machine learning models 252. A machine learning model is a type of artificial intelligence model that can learn without being explicitly programmed. A machine learning model can learn based on training data input into the machine learning model. The machine learning model can learn using various types of machine learning algorithms. These machine learning models can be trained using data and process additional data to provide a desired output.

There are three main categories of machine learning: supervised, unsupervised, and reinforced learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforced learning (RL) methods learn from feedback to re-learn/retrain the models. Algorithms are used to train the predictive model through interacting with the environment using measurable performance criteria.

Machine learning model 252 uses subsets 234 to determine interaction function 236 and at-risk items 238. At-risk items 238 can then be displayed to the user 216 on graphical user interface 214.

Computer system 204 can be configured to perform at least one of the steps, operations, or actions described in the different illustrative examples using software, hardware, firmware, or a combination thereof. As a result, computer system 204 operates as a special purpose computer system in relationship modeler 206 in computer system 204. In particular, relationship modeler 206 transforms computer system 204 into a special purpose computer system as compared to currently available general computer systems that do not have relationship modeler 206. In this example, computer system 204 operates as a tool that can increase at least one of speed, accuracy, or usability of computer system 204, as compared with using current systems.

The illustration of service environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

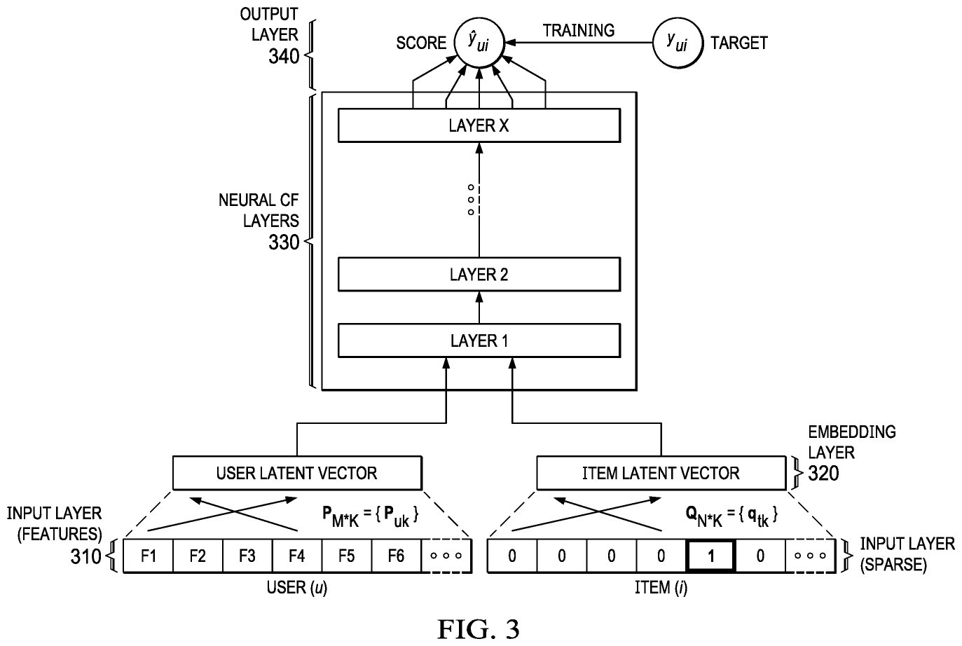

With reference now to FIG. 3, a block diagram of a neural collaborative filtering framework is depicted in accordance with an illustrative embodiment. In this illustrative example, service environment 200 includes components that can be implemented in hardware such as the hardware shown in network data processing system 100 in FIG. 1.

Neural collaborative filtering replaces the inner product of matrix factorization with a neural architecture that can learn an arbitrary function from data. This allows neural collaborative filtering to learn an arbitrary function from the data, being more powerful and expressive than the fixed inner product function of matrix factorization.

The neural collaborative filtering model can be formulated as

ŷᵤᵢ=f(P^{T}νᵤ^{U},Q^{T}νᵢ^{l}|P,Q,Θ_{f})

### Wherein:

P∈ [symbol] ^{M×K} denoting the latent factor matrix for users;
Q∈ [symbol] ^{N×K}, denoting the latent factor matrix for items; and
Θ_{f} denotes the model parameters of the interaction function f.

Input layer 310 consists of feature vectors νᵤ^{U} that describes user u and νᵢ^{l} that describes item i. The feature vectors can be customized to support a wide range of modelling of users and items, such as context-aware, content-based, and neighbor-based. Users and items can be represented by their content features, transformed to a binarized sparse vector with one-hot encoding.

Embedding layer 320 projects the sparse representations from the input layer 310 to a dense vector. The obtained embeddings can be seen as the latent vectors in the context of latent factor model.

Embeddings are then fed into a multi-layer neural architecture, comprising a set of neural collaborative filtering layers 330. Each layer of the neural collaborative filtering layers 330 can be customized to discover certain latent structures of user-item interactions, mapping the latent vectors to prediction scores ŷᵤᵢ.

The function f is defined as a multi-layer neural network, formulated as:

f(P^{T}νᵤ^{U},Q^{T}νᵢ^{l}))=ϕₒᵤₜ(ϕₓ( . . . ϕ₂(ϕ₁(P^{T}νᵤ^{U},Q^{T}νᵢ^{l})) . . . ))

### Wherein:

ϕₒᵤₜ out denotes the mapping function for the output layer and
ϕₓ denotes the x^{th} neural collaborative filtering layer.

Output layer 340 is the predicted score ŷᵤᵢ. The one-class nature of implicit feedback enables yᵤᵢ to be as a relevancy label. The prediction score ŷᵤᵢ. then represents how likely i is relevant to u. Constraining the output ŷᵤᵢ in the range of [0, 1] enables a probabilistic explanation of NCF, which can be achieved by using a probabilistic function (e.g., the Logistic or Probit function) as the activation function for the output layer ϕₒᵤₜ.

Training can be performed by minimizing the pointwise loss between ŷᵤᵢ and its target value yᵤᵢ, or by performing pairwise learning, such as using the Bayesian Personalized Ranking and margin-based loss. The objective function can then be expressed as:

$$L = - {\sum }_{( u , i ) ∈ Y} {y}_{ui} log {\hat{y}}_{ui} + ( 1 - {y}_{ui} ) log ( 1 - {\hat{y}}_{ui} )$$

The objective function can then be optimized, for example, by stochastic gradient descent (SGD).

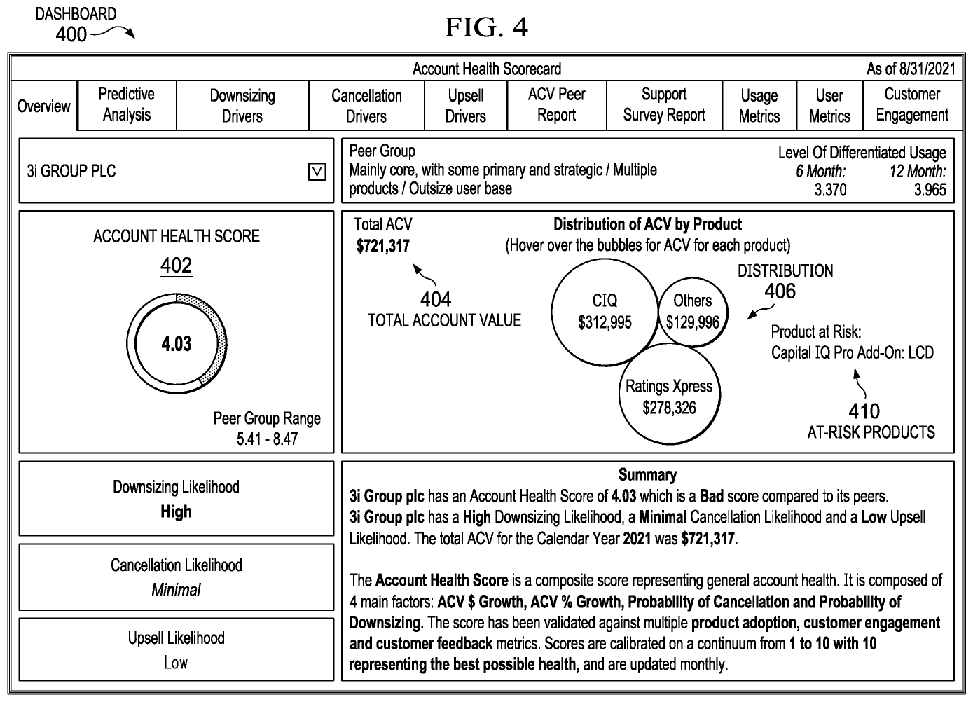

With reference to FIG. 4, a dashboard is depicted in accordance with an illustrative embodiment. As depicted, dashboard 400 is an example one implementation for graphical user interface 214 in FIG. 2. The illustration of dashboard 400 in FIG. 4 is provided as one illustrative example of an implementation for identifying at-risk items and is not meant to limit the manner in which the at-risk items can be identified and presented in other illustrative examples.

Dashboard 400 includes information about an account, which might include an account health score 402, total account value 404, service subscriptions, subscription fees, and a number of user licenses. Dashboard displays a distribution 406 of account value for subscriptions associated with the account.

At-risk items 410 are determined from account data and subscription changes of other accounts. Each at-risk item has a corresponding probability of modification, based on the interaction function determined from machine learning. The probability represents the likelihood of a user making the item change to one or more subscriptions and is constrained between 0 and 1 by the neural collaborative filtering model. The item change can be adding a subscription for an additional item or dropping a subscription for a subscribed item. The probability can be calculated by the machine learning model based on the user's account information, after considering the accounts and item changes of other users.

Distribution 406 can be a subset of the top N at-risk items 410 selected for display to the user. For example, the top 5-6 at-risk items might be shown to the user. The subset of at-risk items might also be selected based on a minimum probability threshold, e.g., 0.6-0.7, wherein anything below the threshold is omitted from the recommendation.

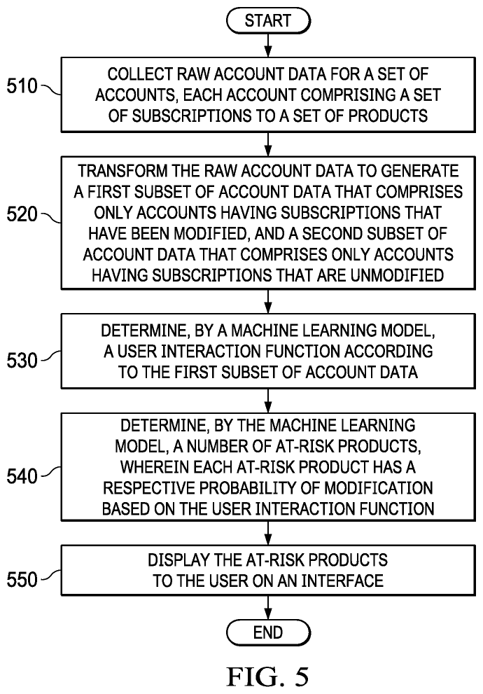

Turning next to FIG. 5, a flowchart of a process for identifying at-risk items is depicted in accordance with an illustrative embodiment. The process in FIG. 5 can be implemented in hardware, software, or both. When implemented in software, the process can take the form of program code that is run by one or more processor units located in one or more hardware devices in one or more computer systems. For example, the process can be implemented in relationship modeler 206 of computer system 204 in FIG. 2.

The process begins by collecting raw account data for a set of accounts, each account comprising a set of subscriptions to a set of items (step 510). In one illustrative example, the raw account data in the collected and stored according to a first periodic time interval, such as daily. Alternatively, the raw account data can be collected in real time in response to account updates, such as a modification to an item subscription. The raw account data can be indexed to facilitate further data interactions.

The process transforms the raw account data to generate a first subset of account data and a second subset of account data (step 520). The first subset of account data comprises only accounts having subscriptions that have been modified. The second subset of account data comprises only accounts having subscriptions that are unmodified. The raw account data can be transformed according to a second period time interval, such as weekly.

Using a machine learning model, an interaction function is determined according to the first subset of account data (step 530). The process then determines a number of at-risk items, using the machine learning model (step 540). Each at-risk item has a respective probability of modification based on the interaction function. The at-risk items can be determined according to the second period time interval. The process displays the at-risk items to the user on a graphical user interface (step 550). The process terminates thereafter.

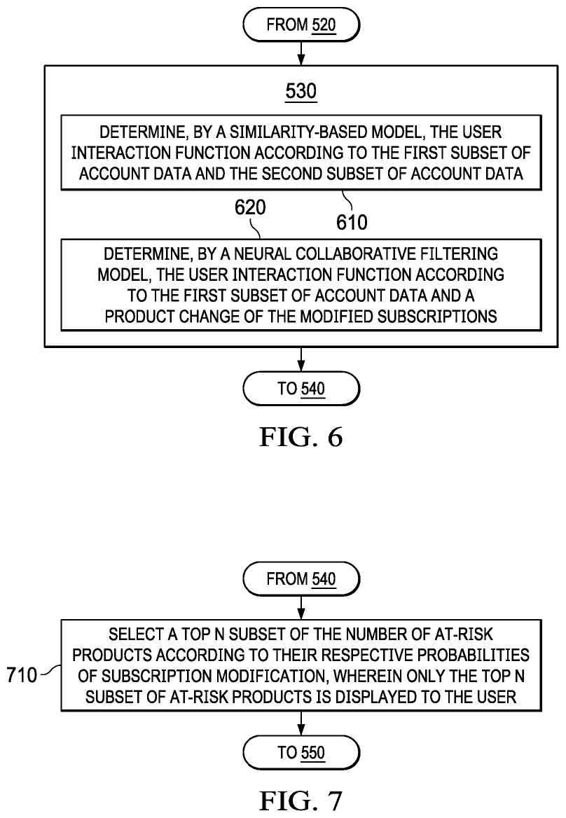

With reference next to FIG. 6, a flowchart of a process for determining an interaction function is depicted in accordance with an illustrative embodiment. The process in FIG. 6 is an example one implementation for step 530 in FIG. 5.

Continuing from step 520, the process determines an interaction function according to the first subset of account data (step 530). In one illustrative example, determining the interaction function can include determining, by a similarity-based model, the interaction function according to the first subset of account data and the second subset of account data (step 610). In one illustrative example, determining the interaction function can include determining, by a neural collaborative filtering model, the interaction function according to the first subset of account data and an item change of the modified subscriptions (step 620). The item change can be an item that has been dropped from the set of subscriptions, an item that has been added to the set of subscriptions, or a combination thereof. Thereafter, the process can continue to step 540 of FIG. 5.

With reference next to FIG. 7, a flowchart of a process for filtering at-risk items is depicted in accordance with an illustrative embodiment. The process in FIG. 7 is an example of additional processing steps that can be performed in conjunction with process 500 of FIG. 5.

Continuing from step 540 of FIG. 5, the process selects a top N subset of the number of at-risk items according to their respective probabilities of subscription modification (step 710). Thereafter, the process continues to step 550 of FIG. 5, wherein only the top N subset of at-risk items is displayed to the user.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

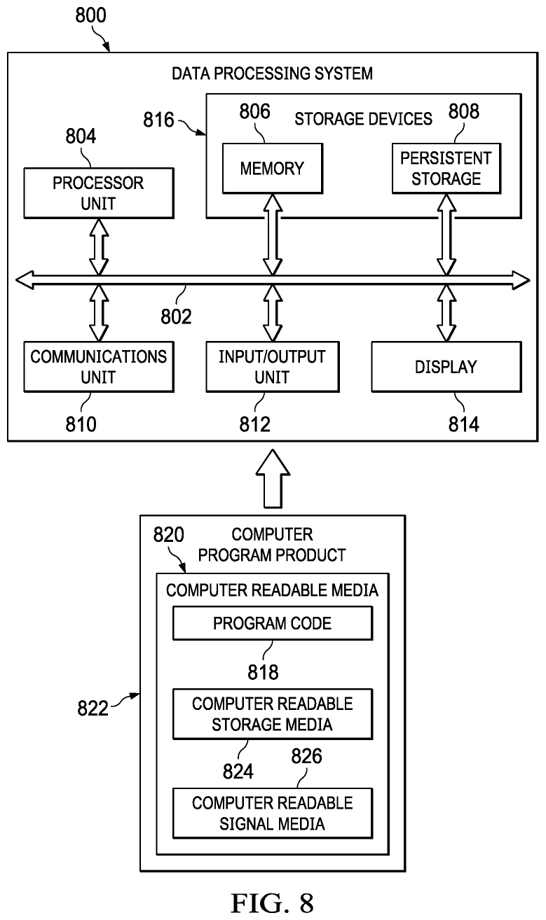

Turning now to FIG. 8, a block diagram of a data processing system is depicted in accordance with an illustrative embodiment. Data processing system 800 can be used to implement server computer 104, server computer 106, client devices 110, in FIG. 1. Data processing system 800 can also be used to implement computer system 204 in FIG. 2. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are program instructions and are also referred to as program code, computer usable program code, or computer-readable program code that can be read and executed by a processor in processor unit 804. The program code in the different embodiments can be embodied on different physical or computer-readable storage media, such as memory 806 or persistent storage 808.

Program code 818 is located in a functional form on computer-readable media 820 that is selectively removable and can be loaded onto or transferred to data processing system 800 for execution by processor unit 804. Program code 818 and computer-readable media 820 form computer program item 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818. Computer-readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, is a limitation of the medium itself (i.e., tangible, not a signal) as opposed to a limitation on data storage persistency (e.g., RAM vs. ROM).

Alternatively, program code 818 can be transferred to data processing system 800 using a computer-readable signal media. The computer-readable signal media are signals and can be, for example, a propagated data signal containing program code 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” can be singular or plural. For example, program code 818 can be located in computer-readable media 820 in the form of a single storage device or system. In another example, program code 818 can be located in computer-readable media 820 that is distributed in multiple data processing systems. In other words, some instructions in program code 818 can be located in one data processing system while other instructions in program code 818 can be located in one data processing system. For example, a portion of program code 818 can be located in computer-readable media 820 in a server computer while another portion of program code 818 can be located in computer-readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of, another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program code 818.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for identifying at-risk items, the method comprising:
using a number of processors to perform the steps of:
collecting raw account data for a set of accounts, each account comprising a set of subscriptions to a set of items;
transforming the raw account data to generate a first subset of account data that comprises only accounts having subscriptions that have been modified, and a second subset of account data that comprises only accounts having subscriptions that are unmodified;
determining, by a machine learning model, an interaction function according to the first subset of account data;
determining, by the machine learning model, a number of at-risk items, wherein each at-risk item has a respective probability of modification based on the interaction function; and
displaying the at-risk items on a graphical user interface.

2. The method of claim 1, further comprising indexing the raw account data.

3. The method of claim 1, wherein determining the interaction function further comprises:
determining, by a similarity-based model, the interaction function according to the first subset of account data and the second subset of account data.

4. The method of claim 1, wherein determining the interaction function further comprises:
determining, by a neural collaborative filtering model, the interaction function according to the first subset of account data and an item change of modified subscriptions.

5. The method of claim 4, wherein the item change is an item that has been dropped in the modified subscription.

6. The method of claim 4, wherein the item change is an item that has been added in the modified subscription.

7. The method of claim 1, further comprising selecting a top N subset of the number of at-risk items according to their respective probabilities of subscription modification, wherein only the top N subset of at-risk items is displayed on the graphical user interface.

8. The method of claim 1, wherein the raw account data is collected and stored according to a first periodic time interval.

9. The method of claim 8, wherein transforming the raw account data and determining the number of at-risk items is performed according to a second period time interval.

10. The method of claim 9, wherein the first periodic time interval is daily, and the second periodic time interval is weekly.

11. A system for identifying at-risk items, the system comprising:
a storage device configured to store program instructions; and
one or more processors operably connected to the storage device and configured to execute the program instructions to cause the system to:
collect raw account data for a set of accounts, each account comprising a set of subscriptions to a set of items;
transform the raw account data to generate a first subset of account data that comprises only accounts having subscriptions that have been modified, and a second subset of account data that comprises only accounts having subscriptions that are unmodified;
determine, by a machine learning model, an interaction function according to the first subset of account data;
determine, by the machine learning model, a number of at-risk items, wherein each at-risk item has a respective probability of modification based on the interaction function; and
display the at-risk items on a graphical user interface.

12. The system of claim 11, further comprising indexing the raw account data.

13. The system of claim 11, wherein in determining the interaction function, the one or more processors are further configured to execute the program instructions to cause the system to:
determine, by a similarity-based model, the interaction function according to the first subset of account data and the second subset of account data.

14. The system of claim 11, wherein in determining the interaction function, the one or more processors are further configured to execute the program instructions to cause the system to:
determine, by a neural collaborative filtering model, the interaction function according to the first subset of account data and an item change of modified subscriptions.

15. The system of claim 14, wherein the item change is an item that has been dropped in the modified subscription.

16. The system of claim 14, wherein the item change is an item that has been added in the modified subscription.

17. The system of claim 11, wherein the one or more processors are further configured to execute the program instructions to cause the system to:
select a top N subset of the number of at-risk items according to their respective probabilities of subscription modification, wherein only the top N subset of at-risk items is displayed on the graphical user interface.

18. The system of claim 11, wherein the raw account data is collected and stored according to a first periodic time interval.

19. The system of claim 18, wherein transforming the raw account data and determining the number of at-risk items is performed according to a second period time interval.

20. The system of claim 19, wherein the first periodic time interval is daily, and the second periodic time interval is weekly.

21. A computer program product for identifying at-risk items, the computer program product comprising:
a computer-readable storage medium having program instructions embodied thereon to perform the steps of:
collecting raw account data for a set of accounts, each account comprising a set of subscriptions to a set of items;
transforming the raw account data to generate a first subset of account data that comprises only accounts having subscriptions that have been modified, and a second subset of account data that comprises only accounts having subscriptions that are unmodified;
determining, by a machine learning model, an interaction function according to the first subset of account data;
determining, by the machine learning model, a number of at-risk items, wherein each at-risk item has a respective probability of modification based on the interaction function; and
displaying the at-risk items on a graphical user interface.

22. The computer program product of claim 21, further comprising indexing the raw account data.

23. The computer program product of claim 21, wherein determining the interaction function further comprises:
determining, by a similarity-based model, the interaction function according to the first subset of account data and the second subset of account data.

24. The computer program product of claim 21, wherein determining the interaction function further comprises:
determining, by a neural collaborative filtering model, the interaction function according to the first subset of account data and an item change of modified subscriptions.

25. The computer program product of claim 24, wherein the item change is an item that has been dropped in the modified subscription.

26. The computer program product of claim 24, wherein the item change is an item that has been added in the modified subscription.

27. The computer program product of claim 21, further comprising selecting a top N subset of the number of at-risk items according to their respective probabilities of subscription modification, wherein only the top N subset of at-risk items is displayed on the graphical user interface.

28. The computer program product of claim 21, wherein the raw account data is collected and stored according to a first periodic time interval.

29. The computer program product of claim 28, wherein transforming the raw account data and determining the number of at-risk items is performed according to a second period time interval.

30. The computer program product of claim 29, wherein the first periodic time interval is daily, and the second periodic time interval is weekly.
